(19) United States
(12) Patent Application Publication
(10) Pub. No.: US 2018/0217588 A1
(43) Pub. Date: Aug. 2, 2018

(54) SYSTEM AND METHOD FOR CONTROL OF AUTONOMOUS MARINE VESSELS

(71) Applicants: Thomas Edwards, Houston, TX (US); Eamon Carrig, Arlington, VA (US); Scott Nguyen, Austin, TX (US); James Nugen, Amherst, MA (US); Walter Holemans, Washington, DC (US)

(72) Inventors: Thomas Edwards, Houston, TX (US); Eamon Carrig, Arlington, VA (US); Scott Nguyen, Austin, TX (US); James Nugen, Amherst, MA (US); Walter Holemans, Washington, DC (US)

(73) Assignee: Autonomous Marine Systems Inc., Somerville, MA (US)

(21) Appl. No.: 15/700,890

(22) Filed: Sep. 11, 2017

Related U.S. Application Data
(63) Continuation of application No. 15/233,436, filed on Aug. 10, 2016, now abandoned.
Application No. 15/233,436 is a continuation of application No. 14/598,211, filed on Jan. 15, 2015, now abandoned.
Application No. 14/598,211 is a continuation-in-part of application No. 13/845,488, filed on Mar. 18, 2013, now Pat. No. 8,973,511.
(60) Provisional application No. 61/616,044, filed on Mar. 27, 2012.

(51) Int. Cl. G05D 1/00; B63B 35/00; B63H 9/06; G07C 5/00; G05D 1/02; B63B 1/12; B63J 99/00

(52) U.S. Cl. CPC G05D 1/0027; B63B 35/00; B63H 9/0607; G07C 5/008; G05D 1/0088; G05D 1/0206; B63B 2213/02; B63B 2035/007; B63B 2035/008; B63B 2203/00; B63B 2211/02; B63J 2099/008; B63B 1/121

(57) ABSTRACT

An apparatus and method for control of at least one of a plurality of semiautonomous marine vessels are provided. The system includes a control station with a communications system for network communication with marine vessels, and provides diagnostics and control for control and monitoring of the marine vessels, according to a mission plan.

### RELATED APPLICATIONS

This application is a continuation of co-pending U.S. patent application Ser. No. 14/598,211, filed 15 Jan. 2015, entitled “System And Method for Control Of Autonomous Marine Vessels,” which is a continuation-in-part and related to U.S. patent application Ser. No. 13/845,488, filed 18 Mar. 2013, and now issued as U.S. Pat. No. 8,973,511, entitled “Autonomous Sailboat for Oceanographic Monitoring”, which claims the benefit of U.S. Provisional Patent Application 61/616,044, filed 27 Mar. 2012, all of which applications are incorporated by reference herein.

### FIELD OF THE INVENTION

The present invention relates to an apparatus and method for autonomous and semi-autonomous marine vessel control. More particularly, the present invention relates to an apparatus and method for operating and controlling an autonomous marine vessel for remote sensing surveys using local currents and drag to optimally search an area.

### BACKGROUND OF THE INVENTION

The world's oceans are among the most difficult and expensive regions to monitor, due in part to the size of the area encompassed by the oceans and the time and resources required to reach remote areas. It is estimated that it would cost about $10-100K per line kilometer to provide a manned monitoring vessel in a remote area, such as the South Pacific. Accordingly, very little oceanographic monitoring is actually performed. In like manner, aerial reconnaissance can be very expensive, and very limited in terms of the range and area that can be monitored during each flight. Manned monitoring vessels or aircraft are also subject to adverse weather conditions, which may limit the times that the monitoring may be conducted, or may place the monitoring personnel at increased risk. Satellite imaging provides some information regarding the condition on the surface and above the ocean, but is substantially limited with regard to conditions under the ocean surface.

There is increasing need to provide more detailed oceanographic monitoring. Concerns abound, for example, regarding increasing levels of hydrocarbons and other materials that are harmful to marine life. In coastal areas, nitrogen runoff from fertilized lands is particularly of concern. The monitoring of fish in particular habitats may provide an early-warning of increasing mortality or decreasing birth rate. In like manner, in the event of an environmental disaster, such as the Gulf oil spill, an accurate monitoring of the extent of the effects of the disaster can aid rescue and repair operations.

Beyond environmental concerns, the increase in pirate activities in certain areas of the world is of concern, as well as the increase in drug trafficking via the seas. Manned surveillance is limited in range and area, and in some cases, dangerous to the surveillance crew.

In addition to addressing particular concerns, the monitoring of oceanographic conditions may enhance our ability to forecast storms and tsunamis, and may enhance marine safety by warning vessels of particularly hazardous conditions. In some cases, the availability of remote monitors on the seas in a region may enhance search and rescue operations in that region.

Typically, ocean data is collected by means and methods of single vehicle sensor deployments, and each of these methods have their own drawbacks. For example, a manned oceangoing vessel is expensive, slow, but has the benefit of direct measurement. Aerial vehicles, which are typically manned for survey, are expensive, rely on indirect measurement, but are relatively fast. Satellites are also used for collecting ocean data, but are very expensive, inflexible and provide only indirect measurement over large areas. Maritime buoys are also employed, and while individually less expensive than other options, they typically must be manually deployed to a location.

One area of data collection involves survey of a quantity to be measured by a manned vessel towing an array of sensors over a geographic area. See FIG. 6 (prior art). In such instance, a vessel tows sensors over a predefined area looking for an item of interest or measuring a specified quantity. In addition to the expense of manpower, there is a drawback to this technique. It is very difficult for an operator of the vessel to alter the survey parameters, such as track of the towed devices while underway. In addition, data that is collected by the sensors must often be analyzed after the survey operation has been completed.

It would be advantageous to provide an affordable means for increasing oceanographic monitoring. It would also be advantageous to be able to provide this increased oceanographic monitoring without requiring personnel at the sites being monitored. It would also be advantageous to provide a reliable and robust monitoring capability with a high likelihood of survivability in hazardous conditions.

These advantages, and others, can be realized by a fleet of autonomous sailing vessels that are equipped with monitoring and communication equipment for reporting environmental and other conditions. For optimal stability and speed, the autonomous sailing vessels are multi-hulled vessels (catamarans) with self-righting capabilities. Each sailing vessel sends and receives information via a communications network which can include one or more satellite links, transmission towers a well as point-to-point links among vessels, and can use solar power to power the communications equipment as well as the monitoring equipment. Each sailing vessel can include an auto-trimming wingsail system to maintain a desired attack angle with the wind (‘angle of attack’), and electric propulsion for use as required when sufficient electric power is available, A modular design is used to support mission-specific payloads.

Often, a survey is planned at the beginning under an assumption of some model of the data. The data is taken and analyzed in order results are the results. Almost always, people realize the survey parameters should have been different and would love to go back and redo the survey. This is very impractical because of the time it takes to do this full cycle data acquisition and analysis, the cost of another survey may be prohibitive. Accordingly, it is an object of the invention to obviate the need for a user to perform the data analysis and inversion, and provide an autonomous solution for the process, and thereby provide a system for performing adaptive distributed surveys.

In addition, by preprocessing and prefiltering, the system provides better real time intelligence than extant methods which simply rely on downsampling. Such feedback can be used to manually tune survey parameters or can be used by an intelligent automatic controller to optimize survey efficacy.

Accordingly, there is a need for an apparatus and method for operating and controlling one or more autonomous or semi-autonomous marine vessels to acquire data on the ocean, waterways and other bodies of water.

### SUMMARY OF THE INVENTION

Aspects of the present invention are to address at least the above-mentioned problems and/or disadvantages and to provide at the least the advantages described below.

Accordingly, an aspect of the present invention is to provide an apparatus and method for control of at least one of a plurality of semiautonomous marine vessels, including a control station, that has a communications system having means for operatively connecting the control station to a communications network for communication with at least one of the semiautonomous marine vessels.

The control station further includes a diagnostic and control system having programming to transmit and receive control information and monitoring information to least one of the semiautonomous marine vessels, and a mission system.

The control information includes navigation information and vessel protocol commands and the monitoring information includes vessel monitoring commands, mission monitoring commands, vessel feedback data, and mission data.

The mission system further includes programming for selecting control information according to at least one mission plan.

Furthermore, it is a further aspect of the invention to provide a control station having a mission system with programming for selecting control information according to at least one mission plan.

Moreover, the control station can further include a mission system having programming for selecting vessel monitoring commands according to vessel feedback data. In addition, the control station can further include a mission system having programming for selecting vessel monitoring commands according to mission data. In addition or in the alternative, the mission plan can be a predetermined mission plan, a manual mission plan, and a client mission plan, and/or a relative mission plan.

Is a further aspect of the invention to provide a control station having a mission system with programming for selecting control information according to at least one mission plan, and programming for modifying control information according to vessel feedback data.

Moreover, the mission system can have programming for selecting control information according to at least one mission plan, and programming for modifying the control information according to mission data.

Additionally, it is an aspect of the invention to provide a control station having a mission system with programming for selecting control information according to at least one mission plan, and programming for modifying control information according internal modification data, and/or external modification data. Internal modification data can include data such as data from internal system modeling and/or user input, learned capabilities of the system and processes of the vessel, and vessel control systems. External modification data can include data such as: weather data, client data, updated protocol data, sensor data and application capability modification data.

Navigation information can include GPS coordinates, a compass headings, waypoints, as well as waypoints selected from a predefined mission plan, as well as a heading relative to a position of another vessel in a fleet of vessels.

Furthermore, vessel protocol commands can include action plan commands, such as: go to waypoint, orbit waypoint, carry on, sleep, and at least one alternative protocol as may be defined by a user, according to certain circumstances.

Is a further aspect of the invention to provide a system having a control station with a mission system having programming for selecting control information associated with a communications unit among a selection of communication devices of a vessel, which can be utilized depending on the circumstances, such as when a vessel approaches a harbor or is in range of a transmission tower and need not rely upon satellite communication. Accordingly, is a further aspect of the invention to provide a mission system having programming for selecting a communications protocol for communicating fleet-wide data among one or more vessels of a fleet.

Another aspect of the invention is to provide a control station having a mission system with programming for preprocessing and prefiltering of vessel feedback data, for example in order to optimize a survey.

Another significant aspect of the invention is to provide a system for marine vessel control and data acquisition of at least one semi-autonomous marine vessel, which can be incorporated into a vessel. The system includes a control unit for a semiautonomous marine vessel for controlling the semiautonomous marine vessel, and for relaying data and control instructions to at least one other semiautonomous marine vessel. The control unit includes a control computer, a location unit, a communication unit, and a vessel control unit. Is a further aspect of the invention to provide the control unit with a mission unit.

Is a further aspect of the invention to provide a system having control unit that can further include a payload management unit, an external interface, as well as programming for selecting an optimal vessel among a fleet of vessels for communication of fleet data. It is a further aspect of the invention to provide the control unit of the system with a memory buffer for receipt and storage for fleet data of one or more vessels of a fleet.

Another aspect of the invention is to provide a system, wherein the control unit includes a mission management system.

Moreover, is a further aspect of the invention to provide the control unit with a control and monitoring system.

Furthermore, another aspect is to provide the control unit with a predetermined navigational protocol, such as to perform a mission.

Another aspect of the invention is to provide a system, wherein the control unit further includes an interface for controlling and/or communicating data with one or more peripheral devices such as: monitoring equipment, global positioning system, inertial measurement units, temperature sensors, wind direction sensors, speed sensors, cameras and hull-speed sensors, among other things. It is a further aspect of the invention to provide a system, wherein the control unit further includes an interface for controlling and/or communicating data with at least one mission-specific monitoring device such as: video and infrared cameras, scanners, acoustic sensors and hydrophones, conductivity sensors, oxygen and other gas sensors, barometers, opto-fluidic water quality sensors, hydrocarbon detectors, Geiger counters, salinity and pH sensors, and pressure sensors.

Other aspects of the invention include a system, wherein the control unit further includes an interface for controlling and/or communicating data with at least one auxiliary vehicles such as: a towed vehicle, submersible tethered vehicle, submersible untethered vehicle, aerial vehicle, and/or third party marine vehicle.

Is a further important aspect of the invention to provide a method of controlling at least one of a number of autonomous vessels in a fleet, which includes creating a mission plan, interpreting a mission plan to provide control information, and communication with at least one the marine vessels, where communicating includes sending and receiving control information to at least one of the vessels.

In addition, it is a further aspect of the method according to the invention to include receiving feedback information from at least one of the vessels, modifying a mission plan in accordance with feedback information from one of the vessels, and to provide a modified mission plan. In addition, the method includes interpreting a modified mission plan to provide control information, and communicating with at least one of the vessel, and such communicating includes sending and receiving control information to the vessel. It is a further aspect of the invention to provide the steps of a vessel receiving control information and performing functions in accordance with the control information.

Another aspect of the invention includes the vessel acquiring feedback information, and communicating the feedback information to at least additional vessel. In addition, an aspect of the invention is the vessel acquiring feedback information, and communicating the feedback information to at least one command vessel.

Accordingly, it is a further aspect of the invention to include the command vessel receiving feedback information, interpreting feedback information to provide a modified mission plan, interpreting the mission plan to provide control information, and communicating the control information to at least one other vessel. Moreover, is a further aspect of the invention to include a command vessel receiving feedback information, interpreting said feedback information to provide a modified mission plan, interpreting said mission plan to provide control information, and communicating said control information to at least one vessel.

Accordingly, aspects of the invention are generally to provide a system of autonomous coordination of one or more vessels as a fleet, acquiring data over a given area.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 illustrates an example concept sketch of a fleet of autonomous vessels that communicate to a user via satellite and internet connections;

FIGS. 2A and 2B (referred to collectively herein as FIG. 2) illustrate an example autonomous vessel in accordance with aspects of this invention;

FIG. 3 illustrates an example block diagram of the communications and control systems of an example autonomous vessel;

FIG. 4 illustrates an example of a system for control of autonomous vessels in accordance with aspects of this invention;

FIG. 5 illustrates example information for use with a system in accordance with aspects of this invention;

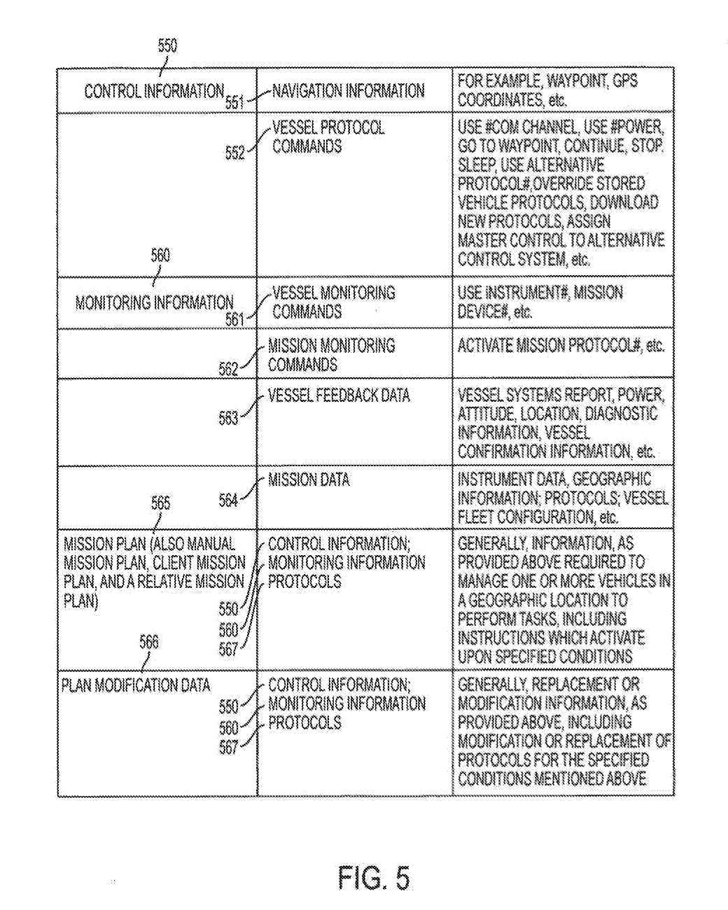

FIG. 6 illustrates a prior art method of surveying;

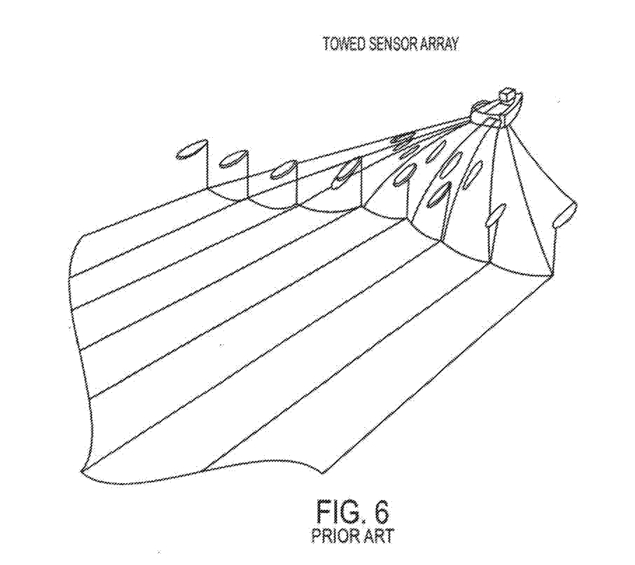

FIGS. 7A, 7B, 7C, 7D, 7E, and 7F (referred to collectively herein as FIG. 2) illustrate several alternative embodiments of mission information for use with a system in accordance with aspects of this invention;

FIGS. 8A AND 8B (referred to collectively as FIG. 8) illustrate an alternative embodiment of mission information for use with a system in accordance with aspects of this invention;

FIGS. 9A and 9B illustrate an alternative embodiments of mission information for use with a system in accordance with aspects of this invention;

FIG. 10 illustrates an example process flow for use with a system in accordance with aspects of this invention;

FIG. 11 illustrates an example process flow for use with a system in accordance with aspects of this invention; and

FIG. 12 illustrates an example process flow for use with a system in accordance with aspects of this invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. This description includes various specific details to assist in that understanding but these examples are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the biblographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,”0“an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variation, including for example, tolerances, measurement error, measurement accuracy limitations and other factors known to those of skill in the art, may occur in amounts that do not preclude the effect the characteristic was intended to provide.

Exemplary embodiments of the present invention include an apparatus and method for operating and controlling an autonomous marine vessel that may be a sailing vessel that is remotely controlled and operated.

Exemplary embodiments of the present invention include an apparatus and method for operating and controlling an autonomous sailing vessel deployable on a variety of bodies of water.

Exemplary embodiments of the present invention include and apparatus and method for operating and controlling an autonomous marine vessel that includes a sail providing locomotive power to the marine vessel using the wind.

Exemplary embodiments of the present invention include an apparatus and method for operating and controlling an autonomous marine vessel that includes a variety of sensors gathering information that may be transmitted and received.

In the present exemplary embodiments, a body type of the autonomous marine vessel is a catamaran body type including two parallel hulls. However, the present invention is not limited thereto, and the autonomous marine vessel may have any suitable body type, such as a catamaran body type including any suitable number of hulls, a body type having only one hull, a body type that is a flat panel, such as a surfboard, a body type that is round, such as a buoy, or any other similar and/or suitable body type for a marine vessel.

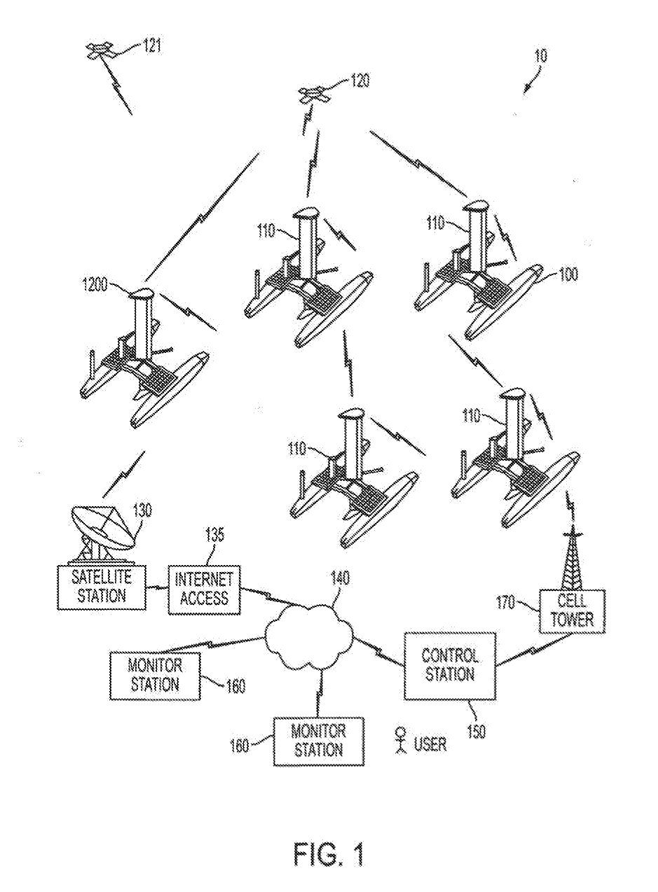

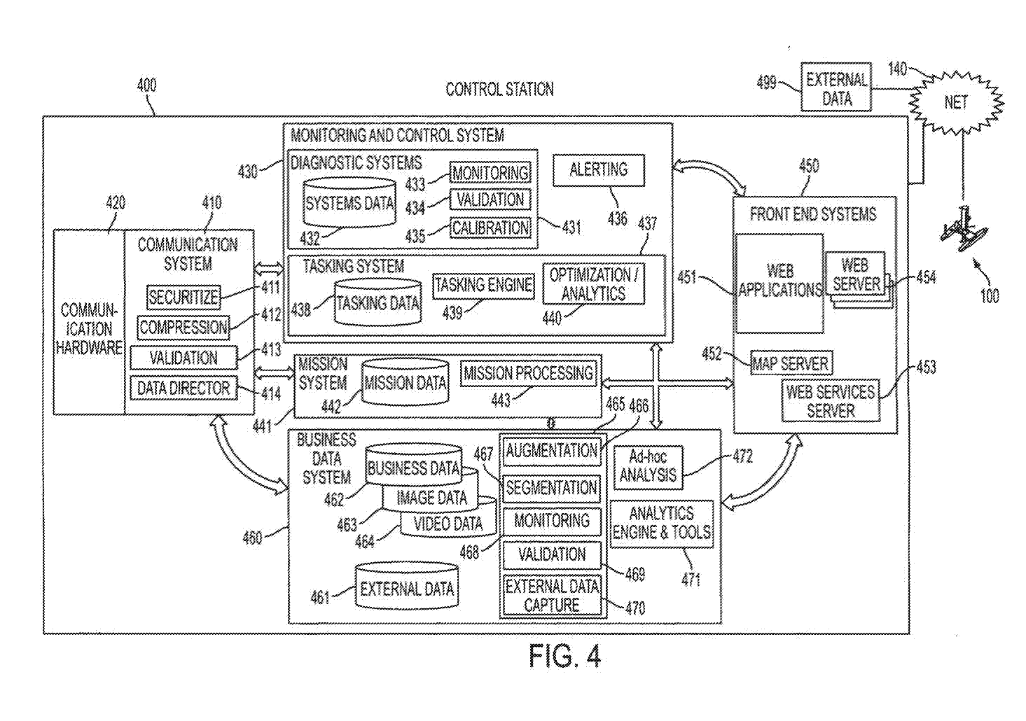

FIG. 1 is a diagram illustrating a system for controlling one or more autonomous marine vessels 100, such as a fleet of boats as shown in FIG. 1. according to one embodiment of the present invention. The system shown includes one or more of: a vessel control unit 110 associated with a vessel 100, a communication network, which can include a satellite 120, control satellite 121, satellite station 130, internet access 135, network 140, and cell tower(s) 170, as well as one or more monitor stations 160, and control stations 150, all of which are communicatively connected by or at least through each other for passing commands, information, and data among other things. Methods and processes provided in the monitoring stations 160, and control stations in 150 of the system 100 are described more fully below with respect to FIG. 4.

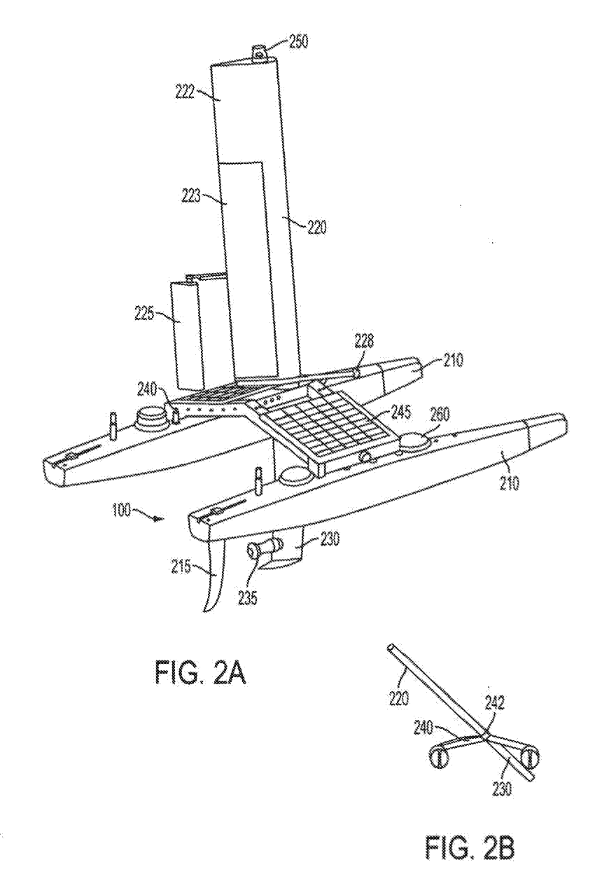

FIG. 2 is a diagram illustrating an autonomous sailing vessel according to an exemplary embodiment of the present invention which can be adapted for use in the system of FIG. 1.

The vessel 100 is more fully described in U.S. patent application Ser. No. 12/845,488 entitled “Autonomous Sailboat for Oceanographic Monitoring” which is incorporated herein by reference, however specific pertinent aspects of the vessel 200 are provided as follows. Referring to FIG. 2, an autonomous sailing vessel 200, which may also be referred to herein as the vessel 200, may include a first hull 210 and a second hull 210 that are disposed so as to be parallel to each other, thus forming a catamaran body type. The vessel 200 may also include a cross arm 240 connecting the first hull to the second hull. An auto-trimming sail 225 may be disposed on the cross arm.

FIGS. 2A-2B illustrate an example autonomous vessel, such as a sailboat 100 in accordance with aspects of this invention. Other configurations are contemplated and a person of skill in the art would appreciate modifications without departing from the scope of the invention. Preferably, the sailboat 100 is relatively small and light, so as not to pose a threat to another vessel in the event of a collision. The example sailboat 100 has a length of about 8 feet, a beam of about 6 feet, and a weight of about 200 pounds, and is equipped with red, green, and white running lights (not illustrated) for optional use at night, particularly in high traffic areas. The vessel 200 can be a self-righting catamaran that includes two wave-piercing hulls 210 coupled together via a truss structure 240, upon which a mast (not visible) with a rotatable sail-wing structure 220 is mounted. The truss structure 240 also supports a keel 230, with an auxiliary propulsion device 235. At least one of the hulls 210 can include a rudder 213. Additionally auxiliary propulsion devices 235 can be used such as by placement on one or more of the hulls. The sail wing structure 220 includes a sail-wing 222, a wind-vane 225, and a counter-balance 228 that allows the sail wing structure 220 to be rotated about the mast with minimal effort. In an example embodiment, the counter balance 228 causes the center of mass of the rotating parts to be coincident with the centerline of the rotary bearings and the center of lift of the sail wing. The vessel 200 includes a control unit 110 having communication and other monitoring equipment 250 at the top of the mast, and water-tight compartments 260 within which additional equipment may be configured. Solar panels 245 are mounted on the wingsail 220 and truss 240 structures and provide the energy required to power the propulsion device 235 as well as the on-board communication, control, and monitoring systems. Optionally, the propulsion device 235 may be configured to generate electricity while the vessel 200 travels under sail.

The example vessel 200 includes four compartments 260. In a typical configuration, one of the compartments includes the navigation and communication control systems and battery storage, and the remaining three compartments are available for mission-specific payload systems. The keel 230 is also configured to contain monitoring devices (not illustrated) for surface and underwater monitoring, such as, telephony equip or acoustic modems, among other things. The hulls 210 and truss structure 240 may also be configured to contain other monitoring devices, depending upon the particular mission.

As illustrated in FIG. 2B, the wingsail structure 220 and keel 230 are rotatable about an axle 242 on the truss structure 240 that runs parallel to the hulls 210. In contrast to the rotation of the wingsail structure about the mast that extends above the truss structure, the rotation of the wingsail structure 220 on the axle 242 results in a rotation about an axis of rotation that is parallel to the hulls 210, whereas the rotation of the wingsail structure 220 about the mast results in a rotation about an axis that is orthogonal to a plane of the hulls 210.

In this example embodiment, the wingsail structure 220 and keel 230 are rigidly coupled together, so that a single actuator (not illustrated) may be used to rotate the combination about the axle 242. Optionally, dual activators could be used to independently control the rotation of the wingsail structure 220 and the keel 230.

In the example embodiment, the center of mass of the wingsail structure 220 and keel 230 arrangement is well above the center of rotation, axle 242. Accordingly, the rotatable keel 230 can be positioned to stabilize the sailboat in high wind conditions by rotating the wingsail structure 220 toward the wind, thereby moving the center of gravity of the sailboat toward the windward hull, reducing the likelihood of the windward hull lifting out of the water (‘flying a hull’) Other techniques of weather helming can also be employed.

In an embodiment with a lower center of mass of the rotating structure 230, the wingsail structure 220 may be rotated away from the wind to reduce the effective sail area presented to the wind, similarly reducing the likelihood of the windward hull lifting out of the water.

The rotatable keel also allows the draft of the vessel 200 to be reduced, allowing the sailboat 100 to travel in shallow waters. Laminated solar cells can be provided on the wingsail surface. The rotatable wingsail structure 220 allows the sailboat 100 to optionally tilt the wingsail to point its solar panels 223 toward the sun, or avoid shading the solar panels 245 on the truss structure 240. Tilting the wingsail structure 120 also reduces the ability to observe the vessel 100, which may be advantageous in clandestine missions. The rotatable wingsail structure 220 also enables righting the sailboat 100 after a capsize, as detailed further below.

Furthermore, the autonomous sailing vessel 200 may include a control unit 110 that controls overall operations of the vessel 200. More particularly, the control unit 110 may control a direction of travel of the vessel 200, and orientation of the vessel 100 if the vessel should capsize or become submerged, and sensor data that may be collected using a plurality of sensors 211 that may be included in the vessel 200. However, the present invention is not limited thereto, and the control unit 110 may control any and all operations of the vessel 100 that may be remotely executed, commanded and/or controlled.

Although not shown in the present exemplary embodiment of FIG. 2, a controller, a Radio Frequency (RF) transceiver, a Global Positioning System (GPS) receiver or any other similar and/or suitable position information receiver, a battery unit, a memory, and at least one of the plurality of sensors 211 may be included in the control unit 110. The RF transceiver may be used for transmitting and/or receiving any type of RF signal used for wireless communication. The controller may execute processing, computations, and communication functions and operations for the controlling of the overall operations of the vessel 200. The controller may read data from and write data to the memory which may be employed to store data used for the control of the operations of the vessel 200, data generated by the plurality of sensors 211, data transmitted and/or received by the RF transceiver, and any other similar and/or suitable type of data.

The control unit 110 may be placed anywhere on the vessel so long that it may be operatively connected to parts of the vessel, which the control unit controls or communications with. For example, it can be attached to the vessel 100 using an extension arm 212 that may be attached to the cross arm 203. A rudder 213 may be also attached to the extension arm 212. However, the present invention is not limited thereto, and the rudder 213 may be connected to the vessel 200 in any suitable and/or similar manner. The rudder 213 may be connected to the controller included in the control unit 210 using a wired and/or a wireless connection in order to receive a rudder control signal. Accordingly, the controller may control a direction of the rudder 213 using the rudder control signal.

In addition, the vessel 100 may be provided with self-righting capabilities as described in U.S. patent application Ser. No. 13/845,488 entitled “Autonomous Sailboat for Oceanographic Monitoring”.

It is within the scope of the invention to provide alternative embodiments of the vessel 200 and it is not required to provide the specific embodiment of the vessel as a sailboat.

As shown in FIG. 1, the fleet of vessels 100 can be provided in communication with a user via a communication network, including satellite and internet connections as well as one another as a mesh network. In a typical embodiment, the provider of the fleet will configure the vessels based on a particular customer's requirements for mission-specific monitoring tasks. The fleet's movements are controlled by the provider of the fleet, based on directives from customer, and the collection of mission-specific information may be controlled, at least in part, by the customer. The fleet of vessels 100 are deployed to a region to be monitored, and are in communication with a monitor and control station 150 through a communication network for receiving control information and transmitting monitor and other information. Typically, communication with each vessel will be via satellite communication system 120-130, although other forms of communication may be used. For example, in missions that are in proximity of a coast, communications may be provided via cellular networks, using on-shore cell towers 170 which can incorporate other network communication systems, such as the Internet for communication between the monitor and control station 150, and one or more control units 110 of the fleet of vessels 100. Optionally, different communication systems may be used for different applications. For example, navigation information may be communicated via one system, and monitoring information may be communicated via another system. A monitoring and control system 150 communicates control information to the fleet of vessels and receives feedback information from the vessels, via, for example, the Internet network 140. Other monitoring systems 160 may receive monitored information from the vessels, and may optionally be configured to control particular monitoring equipment.

Depending upon the communication system used, the messages will provide destination information. For example, if the Internet network 140 is used, the messages will communicate a destination URL address, or set of addresses, to deliver the message to an internet interface 135 between the satellite communication system 120-130 and the Internet 140. If a cellular network is used, the messages may be text messages that are addressed to one or more destinations. In an example embodiment of the command communication system, each vessel may have an individual communication address, and the fleet may have a fleet communication address, allowing for control of the fleet as a whole, as well as control of individual vessels within the fleet. The control will generally be in the form of navigation commands and monitoring commands. The structure of the commands will be dependent upon the capabilities provided in the vessels 110. For example, if the vessels 110 include navigational software, the control station 150 may only need to communicate navigational information such as target location (e.g., latitude, longitude) and the vessels 110 may determine the direction in which to travel and the vessel commands (e.g., rudder control) to proceed in that direction. In other embodiments, the control station 150 may communicate the direction to travel, and the vessels 110 determine the vessel commands; or, the control station 150 may communicate the vessel commands to each vessel 110. The command structure may range from basic vessel commands to the highest supported navigation commands, allowing the operator at the control station 150 to exercise situation-dependent control of the fleet and individual vessels within the fleet. Each vessel preferably includes a navigation monitor for providing location and tracking information, such as a GPS system that provides the vessel's current location and the speed and direction of travel. This information will generally be communicated to the control station 150, ad well as being used by a control system within the vessel to facilitate vessel control. For example, the tracking information may be used to control the path of the vessel to achieve an optimal “velocity made good” (VMG) toward the target area based on the current wind conditions, including traveling on different “tacks” (bearings and headings relative to the wind) to achieve an overall optimal speed in direction of the target (“tacking” to the target).

Each vessel also includes a variety of monitoring equipment; in some applications different vessels may be outfitted with different monitoring equipment. The vessel monitoring equipment will generally include, for example, the aformentioned GPS (Global Positioning System), inertial measurement units (IMUs), temperature sensors, and wind direction and speed sensors, and may include cameras and hull-speed sensors. The mission-specific monitoring equipment may include video and infrared cameras, scanners, acoustic sensors and hydrophones, conductivity sensors, oxygen and other gas sensors, barometers, opto-fluidic water quality sensors, hydrocarbon detectors, Geiger counters, salinity and pH sensors, pressure sensors, and so on. The monitored information may be communication to the monitoring systems 150, 160 continuously, periodically, on demand, or when triggered. The triggering may be based on changes of monitored values, changes of location, and so on. As noted, the mission-specific monitored information may be provided to one or more monitoring systems 160, and these systems may control some or all of the monitoring equipment.

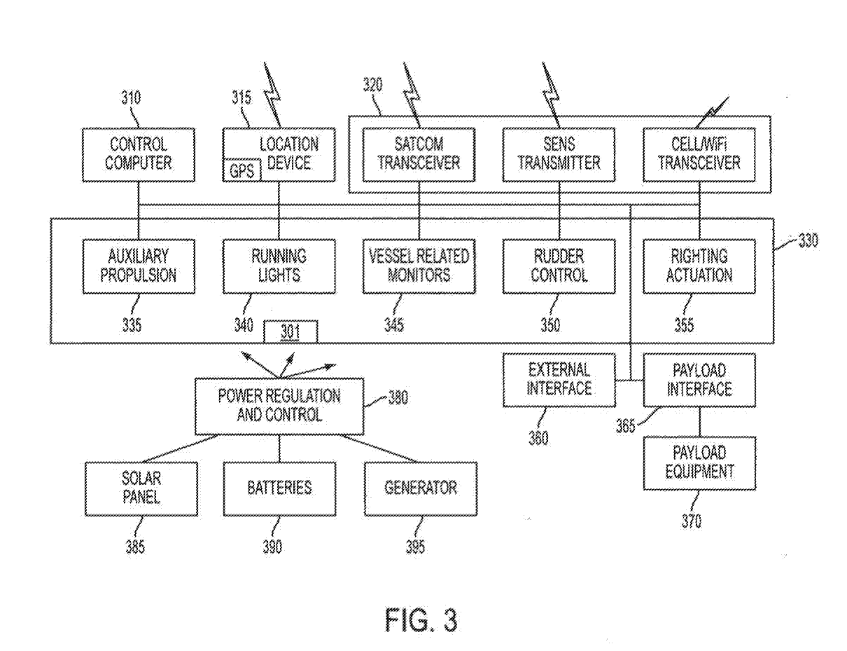

FIG. 3 illustrates an example block diagram of an embodiment of a control unit 110 for communications, control, and monitoring systems for one embodiment of an autonomous vessel 100.

A control computer 310 primarily coordinates the operation of the equipment on the vessel, although some of the equipment may operate autonomously or semi-autonomously. For example, in some embodiments, all external communications are controlled by the computer 310, while in other embodiments, devices send and receive messages directly to and from the individual communication devices. In like manner, the degree of interaction and control of the payload mission specific monitoring exercised by the control computer 310 may vary, depending upon the particular mission and/or the particular type of monitoring.

Although illustrated as a single block, the control computer 310 may include multiple processing systems, including, for example, redundant systems for fail-safe operation and/or embedded systems customized for particular tasks, such as navigation (not shown). The operation of the control computer 310 may best be understood in the context of the equipment on board with which the computer 310 interacts, as follows. The functions of the control computer can be provided as programming for a general-purpose computer having memory and a processor. In such a case, it is contemplated that the control computer 310 may receive from time to time replacement instructions to update and/or modify the system programming of the control computer from a main control station 150.

It is also contemplated that the functions of the control computer can be provided as one or more application-specific integrated circuits (ASICs) especially for embedded processes of standard instrumentation such as communication and GPS as well as navigation systems.

A fundamental piece of equipment for the autonomous sailboat is a location device such as a GPS receiver 315 that receives messages from a plurality of satellites, from which the latitude and longitude of the receiver 315 (and thus the location of the sailboat) is determined. Other means can be employed for providing location such as programming and instrumentation to perform alternative approaches to be used GPS denied environments, such as dead reckoning or celestial navigation which the control computer may chose under varying circumstances. Depending upon the capabilities of the GPS receiver 315, other information, such as the speed and direction of travel, may also be provided; or, another element, such as the control computer 310 may determine the speed and direction of travel from the reported locations over time. Other means and methods for a location device are contemplated, such as self triangulation from measurements with other vessels of the fleet. This location information is provided on the communications bus 301 for use by any of the devices on this bus 301. As noted above, the control computer 310 may use the current location of the vessel to determine a route to a target area, may use the speed and direction of travel information to trim the rudder to compensate for drift, and so on. The location information may also be included in each of the monitoring messages that are transmitted from the sailboat.

Another fundamental piece of equipment for the autonomous sailboat is a communication device for reporting the monitored and control information. In the example of FIG. 3, a plurality of satellite communication devices 320, 325 are provided, although fewer or more communication devices may be provided. The example satellite communication (Satcom) transceiver 320 is a conventional satellite messaging system, such an Iridium transceiver. The transceiver 320 receives messages that are addressed to the sailboat and provides these messages on the bus 301. A particular sailboat may have multiple addresses, such as an address for receiving sailboat related messages (e.g., navigation messages) and another address for receiving payload related messages (e.g., monitor control messages); alternatively, all messages may be addressed to a single address and a message protocol may be established for distinguishing the received messages. In some configurations, groups of sailboats are assigned a common address for receiving ‘fleet’ or ‘sub-fleet’ related communications. The control computer 310 may be configured to receive and process the messages for communicating specific information to particular devices, and/or some of the devices may be configured to receive and process particular messages directly.

In like manner, messages may be transmitted from the sailboat via the transceiver 320. These messages may be formatted by the control computer 310 based on information received from devices on the sailboat, or some devices may be configured to provide messages directly to the transceiver 320. The messages may be addressed to a common address, relying on the receiver at that address to route the messages to the appropriate recipients, and/or different addresses may be used to directly communicate particular messages to particular recipients.

The ability to use a commercial satellite communication system for transmitting and receiving messages provides substantial flexibility in the form and content of the messages. Custom formats may be defined for these communications, using, for example, HTML schemas. In some embodiments, a mix of custom and standard formats may be used. For example, the National Marine Electronics Association (NMEA) provides a protocol standard, NMEA 200, that is used for communicating navigation, control, monitoring, and other information among marine devices. Others include a field bus, and can bus î2C, among other things. The control computer 310 may be configured, for example, to send and receive NMEA formatted messages from and to the on-shore monitor and control station (150 of FIG. 2) via the transceiver 320.

The flexibility provided by the use of a conventional satellite messaging system, however, may require a substantial use of resources on the sailboat, and may incur a significant monetary cost for accessing this service. Of particular note, before each message can be sent or received, a synchronous link must be established with the satellite, and this link must be maintained for the duration of the message. Further, each sailboat in the fleet is ‘competing’ with each other sailboat for a satellite channel for establishing the synchronous link. The creation, transmission, reception and decoding, of these messages consume electrical energy, and, after the electrical propulsion system, may be the largest consumer of electrical energy on the sailboat.

Optionally, a low power, limited capability satellite communication system may be used for communicating routine information. For example, the Sensor Enabled Notification System (SENS) is specifically designed to efficiently communicate monitored information. In the example of FIG. 3, a SENS transmitter (or a SENS transceiver) 325 is used for communicating some of the monitored information, thereby off-loading the task of communicating this information via the higher power-consuming transceiver 320.

The SENS transmitter 325 transmits relatively short messages (about 80 bytes) periodically and/or when a reporting event is triggered. These messages typically include an identifier of the transmitter 325, the current GPS location, and parameter values reported from one or more sensors/monitors. The SENS transmitter 525 broadcasts each message automatically, without requiring an establishment of a synchronous link with the satellite system, thereby saving a substantial amount of the time and energy typically required for satellite communications. Because the SENS messages use a fixed format, the creation of these messages can be optimized, further reducing the time and resources consumed for each message.

In an example embodiment, the SENS transmitter 325 may be used as the primary source of location and sensor data, and the satcom transceiver 320 only used when required as the situation demands. For example, the satcom transceiver 320 may be used to receive a command to travel to a target area, and all of the messages sent by the sailboat on the way to the target area are sent via the SENS transmitter 325. In like manner, while in the target area, periodic location and sensor messages are sent via the SENS transmitter 325, and information from other monitors may be communicated via the satcom transceiver 320 when particular events occur.

Other communication systems may also be used in lieu of the satcom transceiver 320. For example, when traveling along the coast or on inland waterways, a cell-phone transceiver or WiFi transceiver 330 may be used. In some embodiments, the WiFi transceiver 330 is used to couple the computer 310 to a network for receiving configuration and other information before being deployed, and/or for testing the equipment on the sailboat before each deployment. Other means for communicating with equipment on the sailboat will be evident to one of skill in the art in view of this disclosure. As discussed above, a main control station 150 may provide updated protocol for communication from time to time, and it is specifically contemplated that the command station 150 may provide the vessel with alternative communication protocols, such as switching from satcom to Wi-Fi when a particular vessel is in proximity to a Wi-Fi station.

It is contemplated that the vessel control unit 310 may be in communication with a main control station 150 and/or monitor station 160, which may send and receive override commands for communication protocol among the several vessels.

It is also contemplated that the vessel control unit 310 may be in communication with an individual vessel acting as a command vessel 1200 or limited peripheral command station having some or all of the functions of a main control station 150, thereby providing boat to boat mesh networking, either as a supplemental or primary means of communication among vessels. In such an embodiment, communication devices 320 can also include Radio Frequency and/or non-emissive communication systems such as laser communications which very difficult to detect remotely or jam.

FIG. 3 also illustrates common equipment 335-355 used to control the sailboat. Additional, or alternative, equipment will be evident to one of skill in the art. The auxiliary propulsion equipment 335 provides forward and reverse propulsion on demand, primarily when the wingsail is unable to achieve sufficient progress toward the target area, unable to maintain location in an assigned area, or when ‘weather-independent’ control is required, such as in high-traffic areas.

The running lights 340 are provided primarily for use in high-traffic areas, and regulatory compliance and can include a set of red, green, and white running lights.

A variety of vessel-related monitors 345 are provided for determining the status of the sailboat and its environment. These monitors 345 may include, for example, a wind direction and speed monitor, a speed-thru-water transducer, voltage and current monitors, inertial monitors, a wingsail orientation monitor, a rudder orientation monitor, heeling-angle monitor, compass heading monitor, and so on.

A rudder control system 350 controls the orientation of the rudder to maintain a given course, change course, correct for drift, and so on.

The righting actuation system 355 includes the actuator(s) required to implement the above described self-righting capability. The actuator may be controlled by commands from the control computer 310, or the system 355 may include the necessary electronics to autonomously execute the righting and heeling-correcting operations described above, based on a reported or determined heeling angle.

Optionally, an external interface 360 may be provided, primarily for configuring and testing the equipment during development and before and after each deployment.

As noted above, the sailboat can be used to convey mission-specific payload equipment 370 to a target area; this payload equipment 370 typically includes a collection of monitoring devices, such as cameras, transducers, and the like, although other types of devices and sensors can be used to be deployed. For example, a loudspeaker system may be provided for making announcements under certain situations, such as when a vessel is detected near a restricted area; a microphone system may also be provided for two-way vocal communications.

Other sensors, included are the mission-specific monitoring equipment that may include video and infrared cameras, scanners, acoustic sensors and hydrophones, conductivity sensors, oxygen and other gas sensors, barometers, and opto-fluidic water quality sensors, hydrocarbon detectors, Geiger counters, salinity and pH sensors, pressure sensors, among other things.

To integrate the payload system into the sailboat control system, a payload interface 365 is provided. This interface may be used for communicating any monitoring commands received from the transceiver 320, communicating monitored information to the control computer 310, or directly to the transceivers 320, 325.

To provide power to the various equipment on the sailboat, a power regulation and control system 360 receives power from a variety of sources, and provides the required power to each of the components of the sailboat. Not illustrated, each of the compartments 260 of the sailboat 100 of FIG. 2A are pre-wired to provide access to power from the system 360, as well as access to the data bus 301 or other onboard networks. In a further embodiment, a priority scheme is used to assure that critical equipment are provided power as required. For example, if the available power is diminished, some equipment may be disabled, while critical equipment, such as the rudder control and righting actuation systems remain enabled.

The power control system 360 receives energy from the solar panels 385 that are mounted on the sailboat, and a battery system 390 stores some of this energy to provide power when the solar panels 585 are not generating electricity. Optionally, the electric propulsion equipment (235 of FIG. 2A) may be configured to include a generator that generates electricity when the wingsail propels the sailboat. Preferably, the electric propulsion system provides minimal resistance while the sailboat is sailing at low speeds, and provides the generator load only when the lift produced is sufficient to support this load while still maintaining a given minimal speed. Other kinetic power harvesting techniques may be employed as well such as a Witt generator.

It is significant to note that when the vessels are deployed as a fleet, measurements within an area can be obtained from vessels at different locations within the area. Such multiple measurements may allow for determining a location of a detected object via common location determining techniques, such a triangulation based on a determined range, direction, or orientation of the detected object from the different vessels. It is also significant to note that although a relatively random positioning of vessels within a given target area may commonly be used, other deployment schemes may be used, such as a controlled positioning of each vessel to assure that each point within the target area is within the monitoring range of at least one vessel, or a positioning of all of the vessels in a given pattern, such as a picket line, to assure that all objects approaching or crossing the picket line are detected. One of skill in the art will recognize that the location of a vessel may be controlled to be within a defined area by traveling (tacking) back and forth within the area, thus allowing, for example, the establishment of a picket line across the entrance to a particular waterway, with each vessel having an assigned area along the picket line.

FIG. 4 illustrates a further embodiment of a system having the control station 150 shown in FIG. 1, which is provided in communication with the fleet of vehicles 100 in addition to other parts of the communication network 140 such as main command station, peripheral command stations, as well as an optional external data source 499. For example, in one embodiment, there is a command station 150 on the mainland, and one or more peripheral control or monitor stations 160 on the water in communication with the fleet.

The exemplary control station 400 shown its FIG. 4 can comprise standard computer software and hardware, such as memory, and a processor, as well as programming to effect the certain functions described herein. In addition or in the alternative, the control station 400 may include application-specific integrated circuits for one or more functions.

The control station includes a communications system 410 having means 420 for operatively connecting the control station to a communications network for communication with at least one of the semi-autonomous marine vessels. The communication means 420 can include one or more devices depending on the corresponding devices of the vessels 320, such as Satcom, SENS, Cell/WiFi, Laser, and RF among other things. The communication system can also include a securitize module 411, a compression module 412, a validation module 413, as well as a data director 414. Among other things, the communication system 410 can be provided with programming to enable and “always up” queuing process for receiving and transmitting data. In addition, the communication system 410 can be provided with programming to transform packet stream to Internet protocol messages, as well as optimized data for transmission, as well as programming to provide for secure communication. Among other things, it can be appreciated that data that is communicated can be prioritized depending on the circumstances.

Specifically, the data director 441 can be provided with programming to optimize transmission from vessel to vessel and/or vessel to satellite or vessel to an alternative receiver, such as a wireless tower. In addition the data director 441 can be provided with routing information for sending communications to specific vessels.

The data director 441 can be provided with an analytic storage, and processing for collecting statistical communication's data over time. This can be especially important, for example, when communications are not secure, or transmission bandwidth is limited, or transmission power is an issue. Accordingly, the data director 441 can be provided with programming to prioritize transmission of commands according to a prioritized command list. In addition, the data director can be provided with a communications protocol to manage communications under varying circumstances.

Accordingly, the control station, discussed below, can include a mission system having programming for providing instructions to one or more modules of the communication system for functioning of its modules, such as selecting control information to be transmitted to a vessel to direct the vessel to utilize a particular communication device under predetermined conditions under a mission plan, such as switching from satcom to Wi-Fi or laser for communications. For example, a mission plan may require different modes of communication, depending on geographic location, such as when approaching a harbor or when the vessel has low power or is in a compromised state or in an area of high security. Alternatively, when a fleet is operating autonomously or semi-autonomously as a meshed network, and substantially independent of a primary control station, being controlled by a vessel having functionality of a control station, the communication may be primarily using point-to-point communication devices, such as laser.

In addition, the control station includes a monitoring and control system 430 having programming to transmit and receive control information 550 and monitoring information 560 to least one of the semi-autonomous marine vessels 100. The control system 430 interprets a mission plan and its protocols to create control information and monitoring information. In one embodiment of the invention, the control system 430 can additionally, or in the alternative, send all or part of a mission plan to one or more of the vessels, such as when one of the vessels has programming to receive a mission plan, and perform one or more functions of a command station.

In one exemplary embodiment, the monitoring and control system 431 includes a tasking system 437. The tasking system 437 controls the tasks being performed by the vehicle. In general, the tasking system communicates command and control information 550, and can translate mission instructions or protocols to navigation information 551 and vessel protocol commands 552. Vessel protocol commands 552 can include vessel protocol commands include action plan commands, selected from the list of go to waypoint, orbit waypoint, carry on, sleep, and at least one alternative protocol, among other things.

Control information 550 can include navigation information 551, such as waypoints, GPS coordinates or other information for navigation, as well as vessel protocol commands 552, such as an instruction for the vehicle to use a specific communication channel and/or communications device, among other things. In addition, the tasking system 437 can be provided with programming to maintain and store control information 550, and for historical auditing and optimization. Furthermore, the tasking system 437 can be provided with programming to optimize macro navigation via high-level information (geographical features, known environmental conditions, traffic analysis, and/or historical experience) as well as a rudimentary form of dead reckoning.

In one exemplary embodiment of the invention, the tasking system 437 can include one or more submodules, including a tasking database storage 438 for storing the data, tasking engine 439 for processing the functions of the tasking system 437, and/or a separate optimization/analytics module for optimizing the instructions and tasks performed by the tasking system 437.

Furthermore, in an alternative embodiment, the control station can include a diagnostic systems module 431 for managing the monitoring information 560. Monitoring information can include vessel monitoring commands 561, such as commands for using a diagnostic instrument or other device on the vessel. In addition, monitoring information 560 can include vessel feedback data 563, such as the vessel systems reports, power, attitude, location, and other diagnostic information 565. Among other things, the diagnostic systems module 431 can include one or more submodules including a systems data storage, 432, a monitoring submodule 433, a validation submodule 434, and a calibration submodule 435. The diagnostic systems module 431 collects, maintains and stores diagnostic information related to vessels systems and thereby ensures the integrity of the systems and the ability to maintain the systems. In addition, it provides for an infrastructure for problem analysis and/or predictive failure analysis. Moreover, the diagnostic systems module 431 can provide an infrastructure for sensor recalibration based on data quality and diagnostic information. The diagnostic information 565 collected by the diagnostic system 431 can be fed into one or more of the other engineering systems, such as maintenance, refurbishment and/or manufacturing systems.

While the foregoing has been described in terms of specific modules and submodules, it can be appreciated by those skilled in the art that many forms of programming can be provided to perform the functions specified herein, whether provided in one or more modules and/or whether separate or distributed in their execution.

Accordingly, at least one software module embodied in a form of electronic storage provides for at least the function of the monitoring and control system 430, whose purpose is to manage the control information which includes navigation information and/or vessel protocol commands, and managing the monitoring information. The monitoring information includes vessel monitoring commands, mission monitoring commands, vessel feedback data, and/or mission data.

Although it is contemplated that a user can input mission data into the tasking system for directing one or more of the vessels, in an alternative embodiment of the invention, the control station 400, can also be provided with a mission management system 441. The mission management system 441, or mission system, includes programming for selecting control information 550 according to at least one mission plan 565. In addition, the mission system includes programming to define and store a mission database for historical auditing, and maintains mission status and vehicle availability.

In an alternative embodiment, the mission system 441 can communicate mission system data with other business systems, such as the business data system 460. For example, the mission system 441 may communicate contracts, billing, and other information for a particular mission plan desired by a particular client with the business data system 460. Similarly, the mission system includes programming for selecting vessel monitoring commands according to vessel feedback data in accordance with a mission. Furthermore, the mission system can select vessel monitoring commands according to mission data.

Accordingly, the control station includes a mission system having programming for selecting control information according to at least one mission plan. In addition, a mission plan can be selected from a number of mission plans, including a predefined mission plan, a manual mission plan set by user on an ad hoc basis, a client mission plan received from a client, and a relative mission plan, which can be selected according to certain circumstances. Thus, a mission system can select control information according to at least one mission plan, and programming for modifying the control information according to mission data, and communicate such to the fleet through the monitoring and control system 430.

Another aspect of the mission system is programming for selecting control information according to at least one mission plan, and programming for modifying the control information according to vessel feedback data. For example, vessel feedback data can indicate a vessel out of operation, which may require alteration of the mission plan. Similarly, vessel feedback data may include data from instruments that require change of a mission pan according to mission protocols.

It can be appreciated by a person of skill in the art that the mission management system 441 can comprise a mission data storage 442 and mission processing 443 in order to accomplish the above stated functions of the system 441.

Greater detail of the mission system 441 and monitoring and control system 430, and their functioning for additional alternative embodiments are provided below with respect to FIGS. 4, and 7-12, and the accompanying written description.

The control station 400 can also include a front-end system 452 to permit a user interface to define and store missions in a database of the mission system 441. Preferably, the front-end system 450 is a web-based data explorer including data visualization, geographic mapping, and real-time imagery and video. In addition, the front-end system 450 can be provided with data delivery services, as well as an interface for command and control of one or more of the vessels 100. It can be appreciated by a person of skill in the art that the front-end system can be provided with programming, such as a map server 452, Web services server 453, a Web applications module 451, as well as one or more Web servers 454.

In another embodiment of a control station 400 according to the invention, a business data system 460 can also be included. The business data system can be provided with programming by a person of ordinary skill in the art to maintain and “always up” warehouse of accumulated data from one or more missions in one or more data storage modules, such as a business data storage 462, image data storage 463, and/or a video data storage 464, among other things.

In addition, the business data system 460 can be provided with programming for business data processing 465. In general, the business and data system can validate and monitor data quality, retrieve and maintain a warehouse or database, externally source complementary data, provide applications for dataset queries and ad-hoc data access, as well as establish an infrastructure for data analytics of accumulated data. The business data processing 465 can comprise one or more software modules to effect these functions, including an augmentation module 466, a segmentation module 467, a monitoring module 468, a validation module 469, and/or an external data capture module 470, In addition, a separate ad-hoc analysis module 472 and/or and analytics engine and tools module 471 can be provided.

Aspects of a system invention according to the invention are further detailed below with respect to specific embodiments adapted to coordinating a fleet of vessels tor certain tasks.

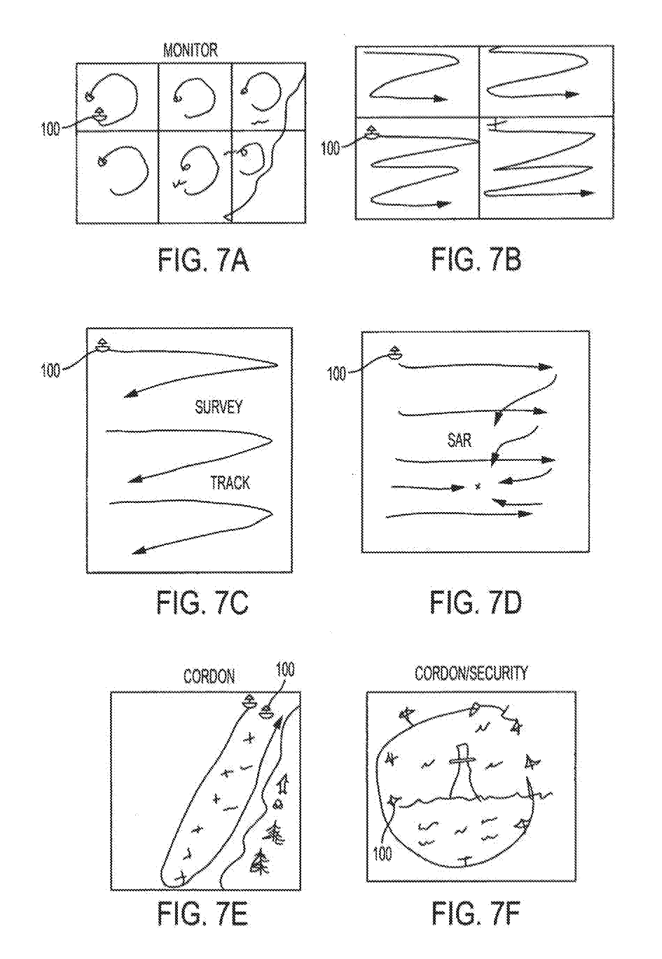

FIGS. 7A-7F illustrate a plurality of predefined mission plans for an embodiment of a system according to the invention. FIGS. 7A and 7B show a fleet of vessels selected to cover a defined geographic area in a grid, wherein each vessel receives navigational commands to navigate in a specific pattern within each cell of the grid. FIG. 7C shows a fleet of vessels selected to cover a geographic area defined by a plurality of tracks. FIG. 7D shows a fleet of vessels, wherein each vessel receives a protocol, including navigational commands to navigate over a track until a condition is met, whereupon the protocol changes those navigational commands when the condition has been met. For example, upon detecting a specific sensor data, such as a first vessel locating a boat in distress, each other vessel in the fleet receives communications from either the first vessel, or the command system of the event meeting the condition, thus triggering a secondary protocol, such as to converge on that point in such a predefined mission plan. FIG. 7E shows a fleet of vessels maintaining a “picket line” formation along a geographical area, such as a coastline. A number of variations, other than a static picket line are feasible, including providing one or more vehicles which maintain a perimeter around the picket line. FIG. 7F shows another variation of a predefined mission plan, whereby a fleet of vehicles maintain a cordon around a specific geographic area, such as an island or fixed maritime assets or in the alternative, a point relative to the fleet, such as a moving vessel. The mission plan can provide that the fleet maintains a static perimeter or follows predefined track. Such may be useful for providing security around an asset, whereby the mission plan can include a condition which is met when a vehicle detects an unknown object or signal within the perimeter, and thereafter performs a function such as alerting a control station, FIG. 7 is provided as example missions and does not represent an exhaustive list. It can be appreciated by a person of skill in the art that other mission plans can be provided to address a specific task, provide optimal use of a particular sensor, and have additional protocols which may dictate alternative actions of the vessels.

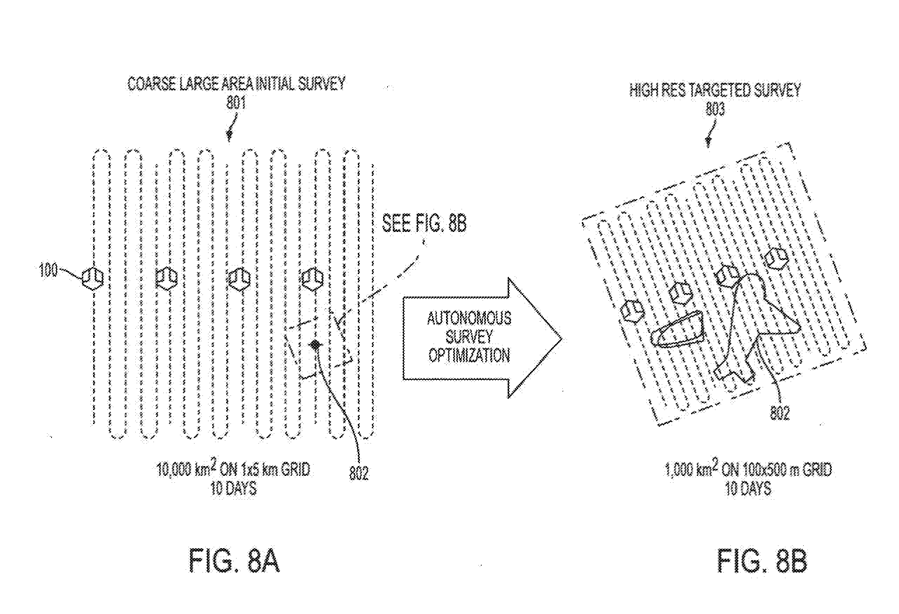

FIGS. 8A and 8B illustrate an embodiment of a predefined mission plan for an embodiment of a system according to the invention having a protocol that can be provided by a user or as part of predefined mission plan. Specifically, a predefined mission plan can include navigation instructions for a fleet of vessels to cover a specified geographic area and to perform a course survey 801. The protocol provided can be modification of the navigation instructions upon a preset condition, such as receipt of feedback information from a vessel upon an event 802, such as detection of something of interest to the survey mission using the vessels survey instrumentation. For example, the modification provided by the protocol can be to provide navigation instructions to effect a high-resolution and targeted survey 803. Thus, a sequential low resolution and a large area survey can be provided to be followed by an autonomous decision to modify the survey area for a higher resolution of the search area.

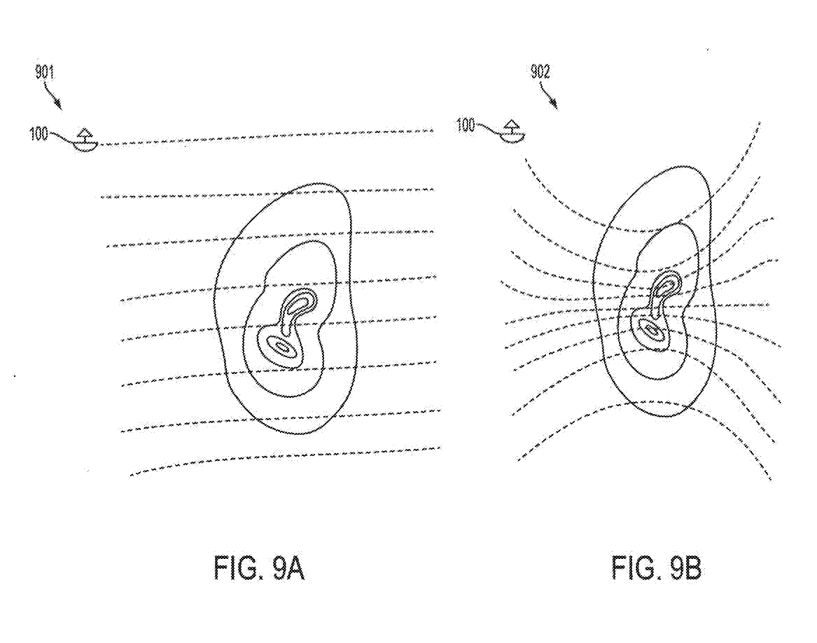

FIGS. 9A and 9B illustrate a predefined mission plan for an embodiment of a system according to the invention having a protocol that can be provided by a user or as part of predefined mission plan. FIG. 9A shows a course survey over an area of interest. Lines are contours of a property to be measured by the survey. Dashed lines are conventional equally spaced tracks. Some tracks completely miss the features. FIG. 9B shows a: dynamic high resolution survey. Lines are the contours of a property to be measured by the survey. Dashed lines are the dynamically defined survey tracks from the autonomous swarm algorithms. Tracks converge to more efficiently to cover the features.

Specifically, a predefined mission plan can include navigation instructions for a fleet of vessels to cover a specified geographic area and to perform a course survey 901. The protocol provided can be modification of the navigation instructions upon a preset condition, such as receipt of feedback information from a vessel upon an event 802, such as detection of something of interest to the survey mission using the vessels survey instrumentation. For example, the modification provided by the protocol can be to provide navigation instructions to effect dynamic high-resolution surveying. Upon receipt of feedback information, such as instrument readings indicating a relative density of a survey item, such as a geomagnetic anomaly, one or more of the vessel tracks can be dynamically altered to provide high-resolution measurements over areas of high variation and low-resolution measurements over areas of more uniform properties of the survey item 902. In addition, a protocol can be provided so that one or more vessels converge on areas of interest or concentrate their individual instruments over a specific survey area indicated by the protocols.

Another example of an embodiment of the predefined mission plan, according to the invention can be provided in addition to or as an alternative to other embodiments disclosed herein. Specifically, a predefined mission plan can be provided to perform dynamic printer tracking over a defined area. Navigation and control information are provided to each vessel to act locally, and relative to one another, to sample, measure, and track a gradient of a particular measurement. Feedback information can be provided whereby the protocols provide modified navigation control instructions so that the vessels maintain a defined distance apart along the precursor of the measure property, such as an oil spill.

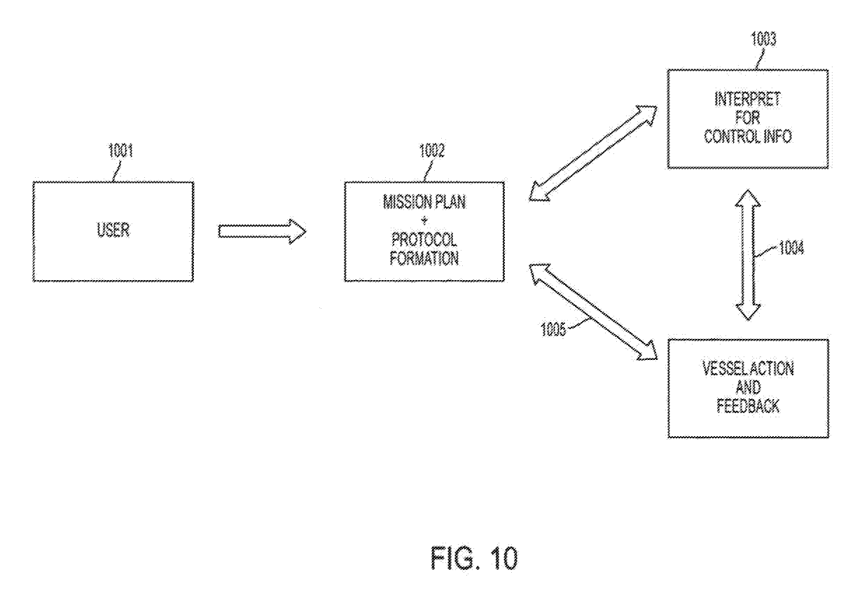

FIGS. 10-12 illustrate, on a high-level, various methods or steps by which data and protocols operate in various embodiments of a system according to the invention.

As shown in FIG. 10, a user 1001 can interact with a mission management system 441 by using a front end system 450 at a control station 400. The user defines 1002 a mission and protocols, i.e. a set of instructions which a monitoring and control system 430 interprets for control 1003 of one or more vessels of a fleet. For example, a user can define a mission by a set of protocols for each vessel in a fleet to act independently on a predefined track on a predefined geographic area to collect data or take other action. Other aspects can also be provided as protocols, such as control of instruments on the vessels while performing the mission. In an embodiment where mission is to perform a magnetic survey, protocols can include instructions to the survey instruments for providing a specified survey resolution or data density that the vessels collects. The control system 432 communicates 1004 with the vessels by providing command instructions to the vessels, and it may receive feedback information 1005 from the vessels as well, such as confirmation of execution of the commands, and feedback can also be sent to the mission system.

More specifically, such feedback information can include whether or not the vessel is on track and had performed its commands, such that upon receipt 705 of the feedback information, the monitoring and control system 430 can interpret the feedback information based on the set of protocols it has received to modify its instructions 1004 which it is sending to the fleet. By this method, a survey fleet can complete its mission, even though unexpected circumstances may occur. For example, by receiving feedback information from a vessel indicating that a single vessel has autonomously avoided an obstacle and has gone of its original survey path, instructions 1004 can be sent to provide fleet wide adjustment of survey tracks whereby the whole fleet adjust their respective tracks to maintain a defined spacing and thereby complete coverage of geographic survey area. Similarly, if a vessel is lost or is otherwise unable perform its function, instructions can be sent to the remainder of the fleet in order to complete the predefined mission.

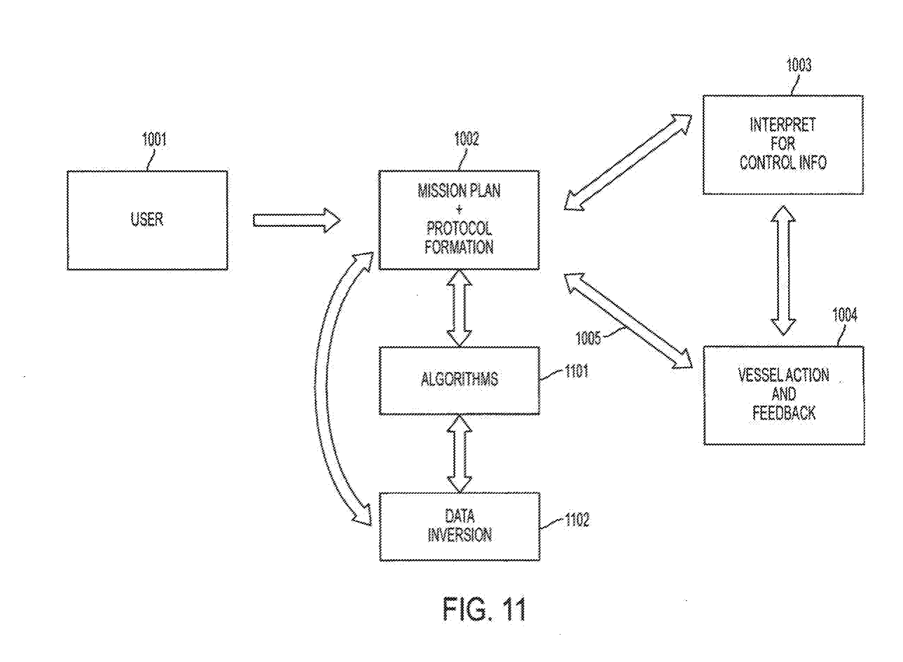

FIG. 11 illustrates a high level view of a further use of feedback and control method and system, which include use of autonomous algorithms including measurement and interpretation feedback information. A user defines 1002 initial survey parameters and provides mission definition information through the user interface. The mission management system translates 1003 the information into the fleet survey commands for use by the fleet in accordance with a mission and/or running one or more survey parameter algorithms 1101. The monitoring and control system sends protocols and command information 1004 to one or more the vessels of the fleet to perform the survey and acquire data. Data can be returned as feedback information to the system which analyzes the data and inverts 1102 the data to yield a model in accordance with the mission parameters. For example, sensor data detecting sub-surface structures can be sent to provide a model or map of the structures below the surface in a geographic area. The quality of the data and the inversion can be assessed by a data inversion model provided by a user as part of a customized mission processing system. For example, this can be done by mapping out the uncertainty in the inverted model. The survey, parameter algorithms takes into account this uncertainty map and defines new survey parameters for the follow-up survey. Thereafter, the mission management system provides this information to the monitoring and control system to define new tasking commands for communication to the fleet, and defining new fleet protocols.

In addition, by preprocessing and prefiltering the system provides better real time intelligence than extant methods which simply rely on downsampling. Such feedback can be used to manually tune survey parameters or can be used by an intelligent automatic controller to optimize survey efficacy.

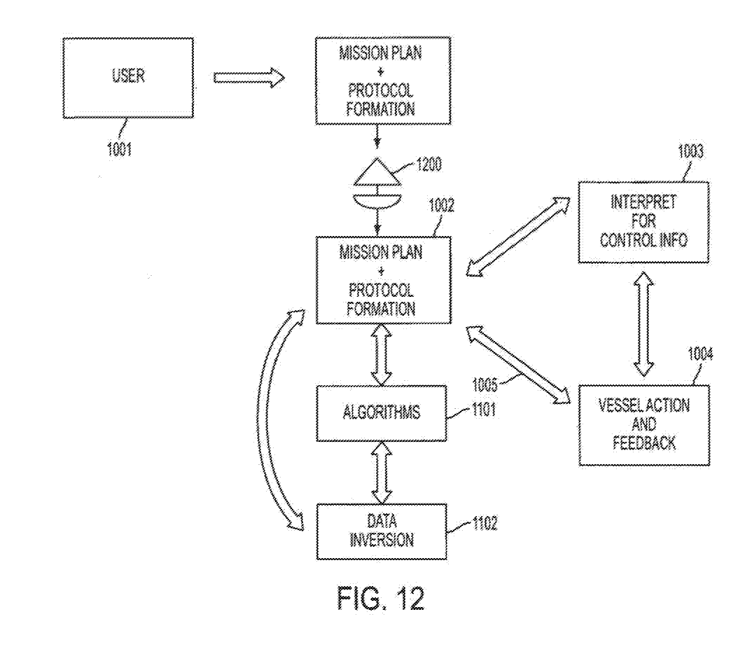

FIG. 12 illustrates a high level of a command vessel 1200 as a limited peripheral command station in accordance with an alternative embodiment of the invention. Once a user 1001 interacts with the mission management system 441 and defines 1002 protocols, those protocols can be programmed to become resident upon a command vessel 1200 having programming adapted to perform all or a portion of the functions of the mission management and command and monitoring systems, and thus act as a limited peripheral command station. For example, the command vessel can be provided with a modified communications unit and include a data director 441 can be provided with programming to optimize transmission from vessel to vessel and/or vessel to satellite or vessel to an alternative receiver, such as a wireless tower. In addition the data director 441 can be provided with routing information for sending communications to specific vessels.

The command vessel 1200 can send instructions to other vessels in the fleet, and modify such instructions upon receipt of feedback information in accordance with a predefined set of protocols programmed into the command vessel as described above with respect to FIG. 10, and to modify its mission in accordance with algorithms and models as described above with respect to FIG. 12. It can be appreciated by those of skill in the art that a reduced instruction set of protocols may be required for programming in order to send modified instructions 1004 based on feedback information 1005 given the limitations of processing power of the command vessel 1200 acting as the limited peripheral command station.

Possible applications for all these networked survey concepts include: Magnetic, Seismic, Gravity, Seep detection, Current, Metocean (Weather), Oil spill tracking, among many other applications including security, surveillance, environmental monitoring and research, among other things.

The use of the word “autonomous,” and “semi-autonomous” include a spectrum of independence of control from complete, to little, and to none. In addition, they include control over vehicle at one instance and of time, and release of control of the vehicle at least another period of time, wherein the vehicle acts independently without requiring confirmation before the vehicle commits to action during at least one other period of time.

While the invention has been shown and described with reference to certain exemplary embodiments thereof, it will be understood by those skilled in the art that various changes in form and details may be made therein without departing from the spirit and scope of the invention as defined by the appended claims and their equivalents.

In interpreting these claims, it should be understood that: a) the word “comprising” does not exclude the presence of other elements or acts than those listed in a given claim; b) the word “a” or “an” preceding an element does not exclude the presence of a plurality of such elements; c) any reference signs in the claims do not limit their scope; d) several “means” may be represented by the same item or hardware or software implemented structure or function; e) each of the disclosed elements may be comprised of a combination of hardware portions (e.g., including discrete and integrated electronic circuitry) and software portions (e.g., computer programming). f) hardware portions may include a processor, and software portions may be stored on a non-transitory computer-readable medium, and may be configured to cause the processor to perform some or all of the functions of one or more of the disclosed elements; g) hardware portions may be comprised of one or both of analog and digital portions; h) any of the disclosed devices or portions thereof may be combined together or separated into further portions unless specifically stated otherwise; i) no specific sequence of acts is intended to be required unless specifically indicated; and j) the term “plurality of” an element includes two or more of the claimed element, and does not imply any particular range of number of elements; that is, a plurality of elements can be as few as two elements, and can include an immeasurable number of elements.

1. A system for control of at least one of a plurality of semiautonomous marine vessels, comprising:
a control station,
said control station including a communications system having means for operatively connecting the control station to a communications network for communication with at least one of the semiautonomous marine vessels,
wherein said control station further includes a diagnostic and control system having programming to transmit and receive control information and monitoring information to least one of the semiautonomous marine vessels, and
a mission system;
wherein the control information includes navigation information and vessel protocol commands;
and the monitoring information includes vessel monitoring commands, mission monitoring commands, vessel feedback data, and mission data;
wherein said mission system further includes programming for selecting control information according to at least one mission plan.

2-35. (canceled)
